(19) United States
(12) Patent Application Publication
(10) Pub. No.: US 2026/0252415 A1
(43) Pub. Date: Aug. 27, 2026

(54) EXTENSIBLE OBJECT MODELING USING EVENT SOURCING AND COMMAND QUERY RESPONSIBILITY SEGREGATION (CQRS)

(71) Applicant: Honeywell International Inc., Charlotte, NC (US)

(72) Inventors: Veeranagegowda Shivalingappa, Hiriyuru (IN); Sumanth Pachipulusu Lingesh, Bengaluru (IN); Aaron Dsouza, Alpharetta, GA (US)

(21) Appl. No.: 19/061,005

(22) Filed: Feb. 24, 2025

(51) Int. Cl. G06F 9/54; G06F 9/451

(52) U.S. Cl. CPC G06F 9/542; G06F 9/451

(57) ABSTRACT

Devices, methods, and systems for extensible object modeling using event sourcing and CQRS are described herein. One method includes receiving, via an interface, a request by a client to modify an entity in an object modeling platform, generating a command responsive to receiving the request, and communicating the command to a first event bus, validating a domain of the command and storing an identifier of the command in a write model persistence layer, generating, responsive to validating the domain of the command, an event associated with the command and communicating the event to a second event bus, modifying the entity in the object modeling platform according to the request responsive to validating the domain of the command, and sending, to the client, an indication of a completion of the command from a query handler.

### TECHNICAL FIELD

The present disclosure relates generally to devices, methods, and systems for extensible object modeling using event sourcing and CQRS.

### BACKGROUND

A platform for extensible object modeling provides customers and integrators the ability to configure and manage master data and digital models for a system, such an HVAC system, a fire system, or a security system, for instance. Digital models can represent objects such as sites, spaces, and/or assets (e.g., equipment), for instance, of the system.

Template-driven modeling allows users to define different object templates that include their own sets of data. Generally, the data of a template is configurable and can include attributes, relationships, metrics, etc.

### BRIEF DESCRIPTION OF THE DRAWINGS

FIG. 1 illustrates a networked computing system environment for extensible object modeling using event sourcing and CQRS, in accordance with one or more embodiments.

FIG. 2 is a screenshot of an example interface including a plurality of object templates, in accordance with one or more embodiments.

FIG. 3 is a screenshot of an example interface including a plurality of object instances, in accordance with one or more embodiments.

FIG. 4A is a portion of a screenshot of an example interface for customizing an object template, in accordance with one or more embodiments.

FIG. 4B is another portion of the screenshot of the example interface illustrated in FIG. 4A.

FIG. 5 is a screenshot of an example interface for customizing an instance, in accordance with one or more embodiments.

FIG. 6 illustrates a flow chart associated with object modeling using event sourcing and CQRS in accordance with one or more embodiments.

FIG. 7 illustrates an example of a method for extensible object modeling using event sourcing and CQRS, in accordance with one or more embodiments

FIG. 8 is an example of a computing device for extensible object modeling using event sourcing and CQRS, in accordance with one or more embodiments.

### DETAILED DESCRIPTION

Devices, methods, and systems for extensible object modeling using event sourcing and CQRS are described herein. One method includes receiving, via an interface, a request by a client to modify an entity in an object modeling platform, generating a command responsive to receiving the request, and communicating the command to a first event bus, validating a domain of the command and storing an identifier of the command in a write model persistence layer, generating, responsive to validating the domain of the command, an event associated with the command and communicating the event to a second event bus, modifying the entity in the object modeling platform according to the request responsive to validating the domain of the command, and sending, to the client, an indication of a completion of the command from a query handler.

As previously discussed, a platform for extensible object modeling provides customers and integrators the ability to configure and manage master data and digital models for a system, such as an HVAC system, a fire system, or a security system, for instance. Digital models can represent objects such as sites, spaces, and/or assets (e.g., equipment), for instance, of the system.

Template-driven modeling allows users to define different object templates that include their own sets of data. The set of data included in a template reflects the type of object it represents. The types of data relevant to a “boiler” template, for example, will differ from the types of data relevant to a “smoke detector” template. Generally, the data of a template is configurable and can include attributes, relationships, metrics, etc.

Using a template, specific instances (referred to herein as “object instances” or simply “instances”) can be created. A template corresponds to a type of object being modeled, and an instance corresponds to a specific object of that type. As an example, the instance “Boiler_1356a1,” representing a specific boiler at a specific location of a facility, can be created from the template “boiler.” Templates can be arranged in a hierarchical structure in that a given template may be a parent template and/or a child template. For example, an “asset” template may have child templates for “fan” and “pump,” the latter of which may have its own child templates for “centrifugal pump” and “piston pump.”

Extensibility is a feature that provides the capability to customize template data during runtime. Additionally, new custom templates can be created with different sets of data by extending existing templates. Because of their hierarchical nature, modifications made to a template can propagate down to the child templates and the individual instances below it.

The present disclosure improves template-driven object modeling platforms by using event sourcing and a Command Query Responsibility Segregation (CQRS) pattern to separate read and write operations into separate models to improve scalability, performance, and maintenance of the platform. According to the CQRS pattern, operations that trigger state transitions are described as commands while data retrieval operations are described as queries. Different persistent techniques can be used for handling commands and queries. Additionally, according to event sourcing, changes to an application's state are stored as a sequence of events. As a result, not only the final state of the application is stored, but also how it was derived. This documentation through event logging provides a better understanding of system usage and can improve user experience with the application.

Operations that trigger changes to an object modeling platform's state (and thus are described as commands) include requests to modify an entity in the object modeling platform. As used herein, “entity” refers to an object instance template and/or a specific object instance. Such modifications can range from creation to deletion and can include customizations or modifications to minor aspects of the entity. The interface of the object modeling platform provides a plurality of configurable options that allow a user to customize the type, manner, timing, etc. of various aspects of templates and/or instances.

As an example, a request can be received from a client via an interface to modify an entity in an object modeling platform. A command can be generated responsive to receiving the request and communicated to a first event bus. A domain of the command can be validated and an identifier of the command can be stored in a write model persistence layer. An event associated with the command can be generated and communicated to a second event bus responsive to validating the domain of the command. The entity can be modified according to the request responsive to a validation of the command and the client can receive an indication of a completion of the command from a query handler and. Segregating state changes (commands) from reads (queries) according to CQRS improves performance and scalability. The log of events can be used for auditing purposes and to improve user experience

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

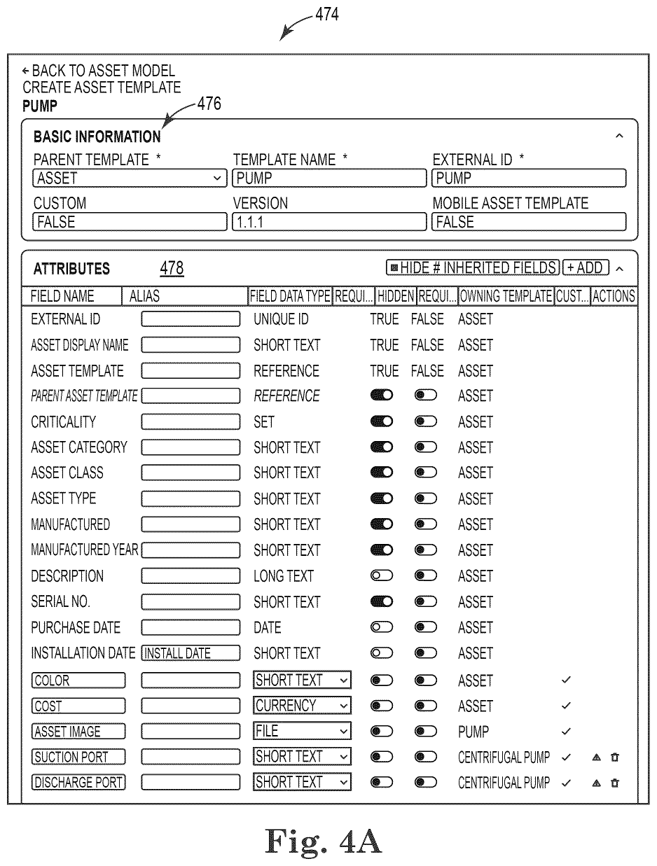

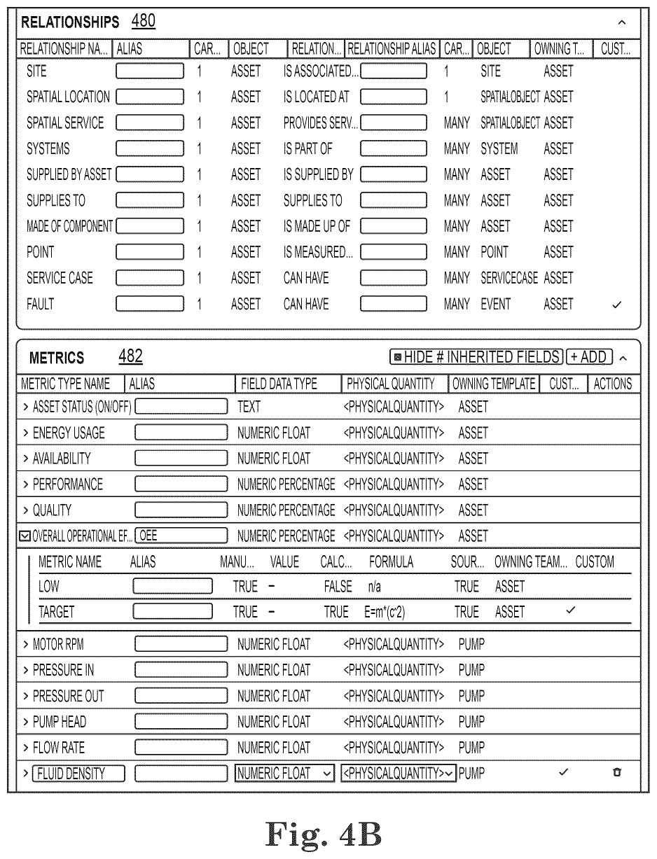

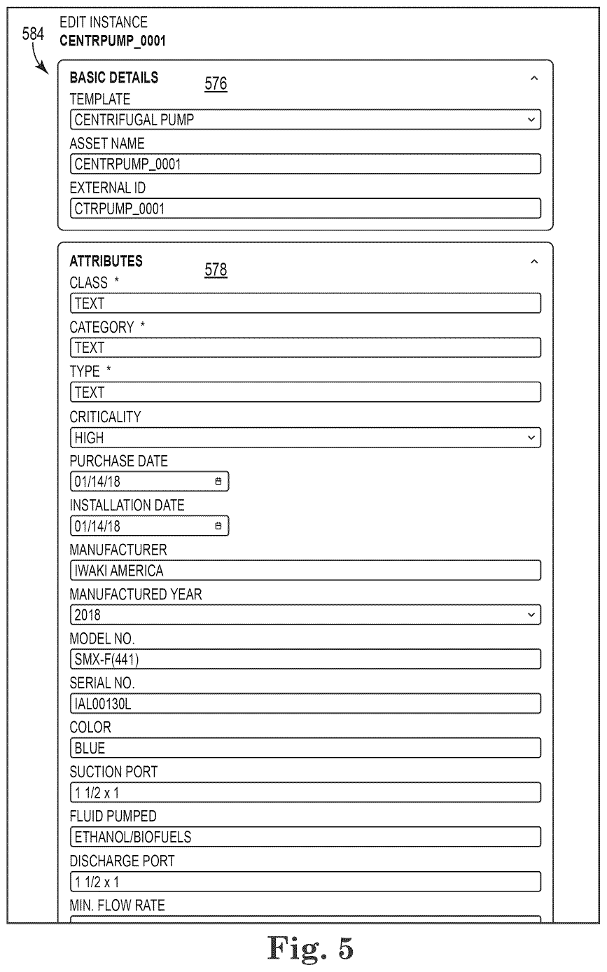

The figures herein follow a numbering convention in which the first digit or digits correspond to the drawing figure number and the remaining digits identify an element or component in the drawing. Similar elements or components between different figures may be identified by the use of similar digits. For example, 476 may reference element “76” in FIGS. 4A and 4B, and a similar element may be referenced as 576 in FIG. 5.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designators “a”, “b”, and “n”, as used herein, particularly with respect to reference numerals in the drawings, indicates that a number of the particular feature so designated can be included with a number of embodiments of the present disclosure.

An object modeling platform in accordance with the present disclosure is an extensible platform that is portable for deployment in any cloud or data center environment for providing an enterprise-wide, top to bottom view, displaying the status of processes, objects, people, and safety. The object modeling platform may include a number of layers including, for example, an extensible object model (EOM) that includes one or more knowledge graphs. The EOM may be a collection of application programming interfaces (APIs) that enables a seeded semantic object model to be extended. The extensible object model further enables a customer's knowledge graph to be built subject to the constraints expressed in the customer's semantic object model. A knowledge graph describes real world entities and their interrelations, organized in a graph. A knowledge graph defines possible classes and relations of entities in a schema, and enables the interrelating of potentially arbitrary entities and covers various topical domains. Knowledge graphs may include large networks of entities, their semantic types, properties, and relationships between entities. The entities may be physical entities or non-physical entities, such as data.

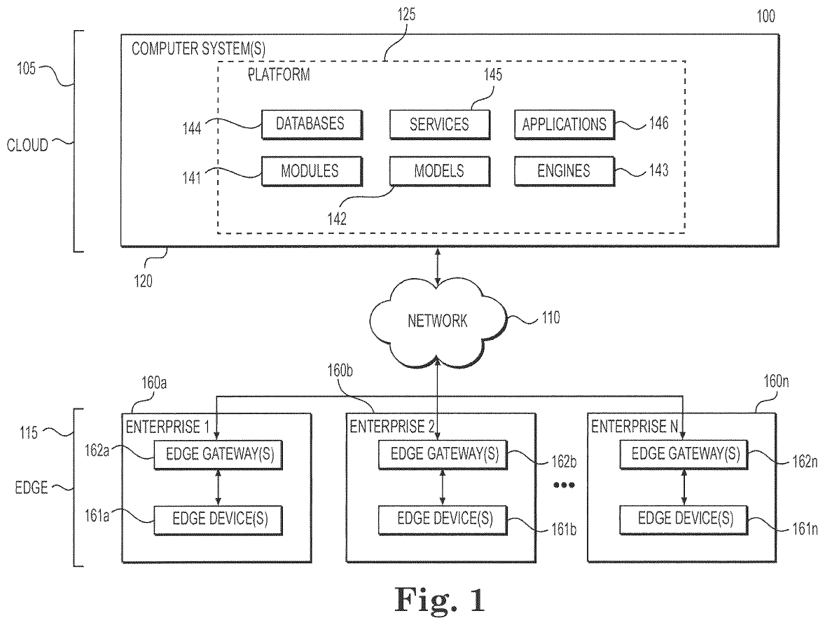

FIG. 1 illustrates a networked computing system environment 100 for extensible object modeling using event sourcing and CQRS, in accordance with one or more embodiments. As illustrated in FIG. 1, networked computing system environment 100 is organized into a plurality of layers including a cloud layer 105, a network layer 110, and an edge layer 115. As detailed further below, components of the edge 115 are in communication with components of the cloud 105 via network 110.

Network 110 may be any suitable network or combination of networks and may support any appropriate protocol suitable for communication of data to and from components of the cloud 105 and between various other components in the networked computing system environment 100 (e.g., components of the edge 115). Network 110 may include a public network (e.g., the Internet), a private network (e.g., a network within an organization), or a combination of public and/or private networks. Network 110 may be configured to provide communication between various components depicted in FIG. 1. Network 110 may comprise one or more networks that connect devices and/or components in the network layout to allow communication between the devices and/or components. For example, the network 110 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 may be implemented using cellular networks, satellite, licensed radio, or a combination of cellular, satellite, licensed radio, and/or unlicensed radio networks.

Components of the cloud 105 include one or more computer systems 120 that form an object modeling platform 125. Computer systems 120 may include any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, the processors and data storage devices may comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100.

Computer systems 120 further include one or more software components of the object modeling platform 125. For example, the software components of computer systems 120 may include one or more software modules to communicate with user devices and/or other computing devices through network 110. For example, the software components may include one or more modules 141, models 142, engines 143, databases 144, services 145, and/or applications 146, which may be stored in/by the computer systems 120 (e.g., stored on the memory). The one or more processors may be configured to utilize the one or more modules 141, models 142, engines 143, databases 144, services 145, and/or applications 146 when performing various methods described in this disclosure.

Accordingly, computer systems 120 may execute a cloud computing platform (e.g., object modeling platform 125) with scalable resources for computation and/or data storage, and may run one or more applications on the cloud computing platform to perform various computer-implemented methods described in this disclosure. In some embodiments, some of the modules 141, models 142, engines 143, databases 144, services 145, and/or applications 146 may be combined to form fewer modules, models, engines, databases, services, and/or applications. In some embodiments, some of the modules 141, models 142, engines 143, databases 144, services 145, and/or applications 146 may be separated into separate, more numerous modules, models, engines, databases, services, and/or applications. In some embodiments, some of the modules 141, models 142, engines 143, databases 144, services 145, and/or applications 146 may be removed while others may be added.

The computer systems 120 are configured to receive data from other components (e.g., components of the edge 115) of networked computing system environment 100 via network 110. Computer systems 120 are further configured to utilize the received data to produce a result. Information indicating the result may be transmitted to users via user computing devices over network 110. In some embodiments, the computer systems 120 may be referred to as a server system that provides one or more services including providing the information indicating the received data and/or the result(s) to the users. Computer systems 120 are part of an entity, which may include any type of company, organization, or institution that implements one or more services. In some examples, the entity may be a platform provider.

Components of the edge 115 include one or more enterprises 160 a-160 n each including one or more edge devices 161 a-161 n and one or more edge gateways 162 a-162 n. For example, a first enterprise 160 a includes first edge devices 161 a and first edge gateways 162 a, a second enterprise 160 b includes second edge devices 161 b and second edge gateways 162 b, and an nth enterprise 160 n includes nth edge devices 161 n and nth edge gateways 162 n. As used herein, enterprises 160 a-160 n may represent any type of entity, facility, vehicle, etc. such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or vehicle that includes any number of local devices.

The objects (e.g., edge devices) 161 a-161 n may represent any of a variety of different types of devices that may be found within the enterprises 160 a-160 n. Objects 161 a-161 n are any type of device configured to access network 110, or be accessed by other devices through network 110, such as via an edge gateway 162 a-162 n. Objects 161 a-161 n may be IoT devices in some instances, which may therefore include any type of network-connected (e.g., Internet-connected) device. The objects 161 a-161 n may be sites, spaces, and/or assets. Assets can include, for example, sensors, actuators, processors, computers, valves, pumps, fans, ducts, vehicle components, cameras, displays, doors, windows, security components, HVAC components, factory equipment, and/or any other devices that may be connected to the network 110 for collecting, sending, and/or receiving information. Each object 161 a-161 n can include, or otherwise be in communication with, one or more controllers for selectively controlling a respective object 161 a-161 n and/or for sending/receiving information between the objects 161 a-161 n and the cloud 105 via network 110.

The edge gateways 162 a-162 n include devices for facilitating communication between the objects 161 a-161 n and the cloud 105 via network 110. For example, the edge gateways 162 a-162 n include one or more communication interfaces for communicating with the objects 161 a-161 n and for communicating with the cloud 105 via network 110. The communication interfaces of the edge gateways 162 a-162 n may include one or more cellular radios, Bluetooth, WiFi, near-field communication radios, Ethernet, or other appropriate communication devices for transmitting and receiving information. Multiple communication interfaces may be included in each gateway 162 a-162 n for providing multiple forms of communication between the objects 161 a-161 n, the gateways 162 a-162 n, and the cloud 105 via network 110. For example, communication may be achieved with the objects 161 a-161 n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

The edge gateways 162 a-162 n may also include a processor and memory for storing and executing program instructions to facilitate data processing. For example, the edge gateways 162 a-162 n can be configured to receive data from the objects 161 a-161 n and process the data prior to sending the data to the cloud 105. Accordingly, the edge gateways 162 a-162 n may include one or more software modules or components for providing data processing services and/or other services or methods of the present disclosure. In some cases, any of objects 161 a-n and edge gateways 162 a-n may have their functionality combined, omitted, or separated into any combination of devices. In other words, an object and its gateway need not necessarily be discrete devices.

The object modeling platform 125 of the present disclosure is a platform for enterprise performance management that uses real-time accurate models and visual analytics to deliver intelligent actionable recommendations for sustained peak performance of the enterprise 160 a-160 n. The object modeling platform 125 is an extensible platform that is portable for deployment in any cloud or data center environment for providing an enterprise-wide, top to bottom view, displaying the status of processes, nodes, people, and safety.

As used herein, “extensible” refers to the ability to extend a data model to include new properties/columns/fields, new classes/tables, and new relations. Thus, the object modeling platform 125 is extensible with regards to objects 161 a-161 n and the applications 146 that handle those objects 161 a-161 n. For example, when new objects 161 a-161 n are added to an enterprise 160 a-160 n system, the new objects 161 a-161 n will automatically appear in the object modeling platform 125 so that the corresponding applications 146 can understand and use the data from the new objects 161 a-161 n.

In some cases, templates are used to facilitate configuration of instances of objects 161 a-161 n in the model using common structures. A template defines the typical properties for the objects 161 a-161 n of a given enterprise 160 a-160 n for a certain type of object. For example, a template of a pump includes modeling the pump having inlet and outlet pressures, speed, flow, etc. The templates may also include hierarchical or derived types of objects 161 a-161 n to accommodate variations of a base type of object 161 a-161 n. For example, a reciprocating pump, a centrifugal pump, and a piston pump would each be a specialization of a base pump type and would each include additional properties in the template. As an additional example, an axial fan would be a specialization of a base fan type and would include additional properties of the template. Instances of the objects 161 a-161 n in the model are configured to match the actual, physical objects of the enterprise 160 a-160 n using the templates to define expected attributes of the object 161 a-161 n. Each attribute is configured either as a static value (e.g., capacity is 1000 BPH) or with a reference to a time series tag that provides the value.

In some embodiments, models and templates can be used to define calculations and analytics, and to define how the calculations and analytics relate to the objects 161 a-161 n. For example, a pump template can define pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. The actual calculation or analytic logic may be defined in the template or it may be referenced. Thus, the calculation model can be used to describe and control the execution of a variety of different process models. Calculation templates can be linked with the node templates such that when an instance is created, any associated calculation instances are also created with their input and output parameters linked to the appropriate attributes of the object.

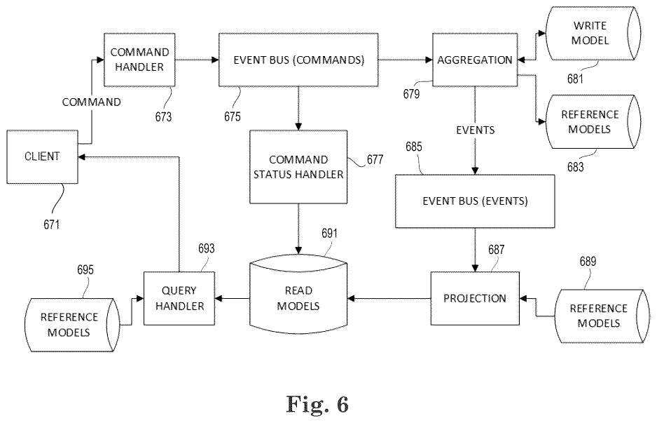

As previously discussed, operations that trigger changes to an object modeling platform's state (described as commands and discussed in more detail below in connection with FIG. 6) include requests to modify an entity in the object modeling platform. Also as previously discussed, “entity” herein refers to an object instance template and/or a specific object instance. Such modifications can range from creation to deletion and can include customizations or modifications to minor aspects of the entity. The interface of the object modeling platform provides a plurality of configurable options that allow a user to customize the type, manner, timing, etc. of various aspects of templates and/or instances.

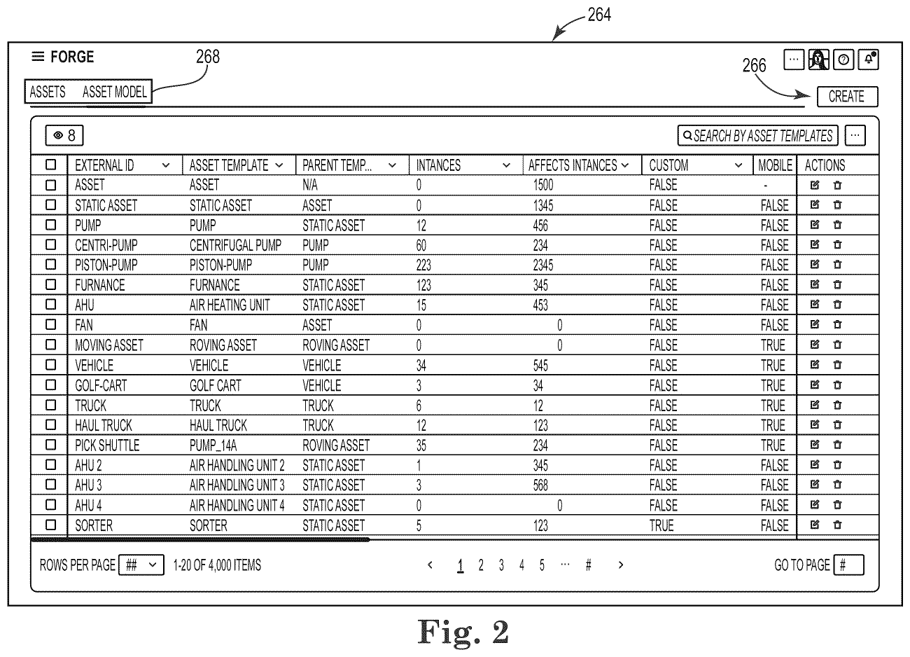

FIGS. 2-5 illustrate screenshots of example interfaces through which a user may traverse in modifying an object template. Such modifications can trigger changes to an object modeling platform's state using event sourcing and CQRS, as described herein. Embodiments of the present disclosure are discussed in reference to these screenshots and in the context of these examples. However, it is again noted that embodiments herein are not so limited; operation(s) to customize a template serve merely to illustrate an example of operations that trigger changes to an object modeling platform's state.

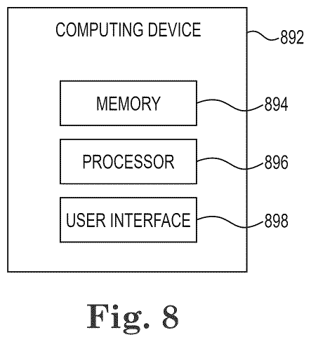

FIG. 2 is a screenshot of an example interface 264 including a plurality of object templates in accordance with one or more embodiments. Interface 264 can be provided (e.g., displayed) as a user interface of a computing device, such as, for instance, user interface 898 of computing device 892 further described in connection with FIG. 8.

As illustrated in FIG. 2, the interface 264 includes a list of object types under the heading “External ID.” It is noted that in the example illustrated in FIG. 2 and elsewhere herein, the specific example of “asset” may be used rather than the broader term “object.” It is to be understood that such usage is not to be taken in a limiting sense; as previously discussed, objects in accordance with the present disclosure include assets, sites and spaces. The names of the templates that correspond to the objects include, for example, “pump,” “centrifugal pump,” piston pump,” “furnace,” “truck,” “static asset,” etc. Additional information corresponding to the templates can be listed in columns, as illustrated in FIG. 2, for instance. This information can include the type of each template, the parent template of each template, the quantity of instances of each template, the quantity of instances affected by each template, and whether each template is a custom template, among other information.

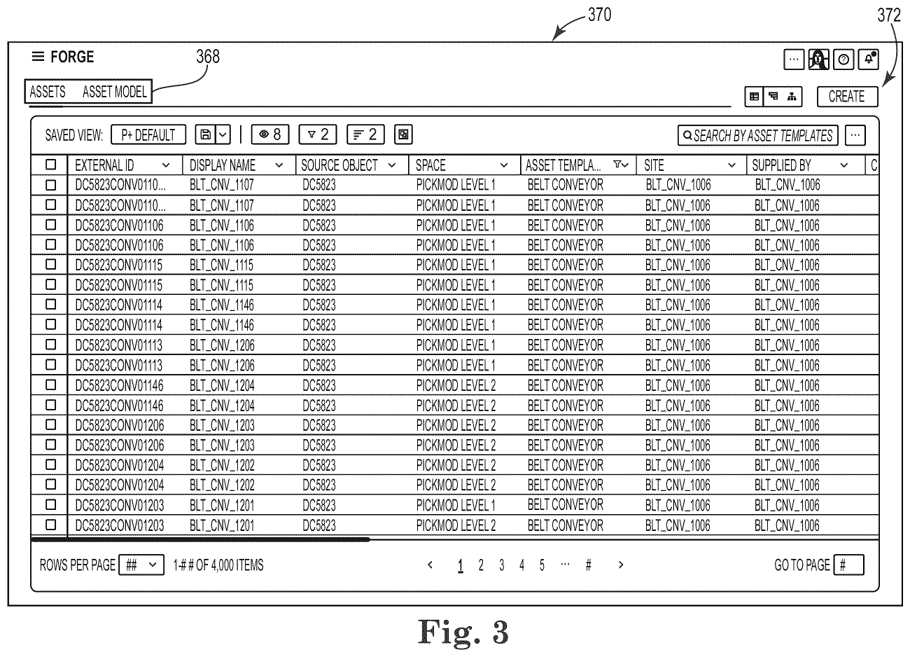

In some embodiments, selection of a template from the list illustrated in interface 264 causes the display of detailed information associated with the selected template. In some embodiments, selection of a template from the list illustrated in interface 264 allows the modification of the selected template. Selection of a display element (“create” button 266) can allow the creation of a new template using a different interface, described below in connection with FIG. 4. Selection of a toggling display element 268 can toggle the display to a plurality of object instances, which is described below in connection with FIG. 3.

FIG. 3 is a screenshot of an example interface including a plurality of object instances in accordance with one or more embodiments. Interface 370 can be provided (e.g., displayed) on a user interface of a computing device, such as, for instance, user interface 898 of computing device 892 further described in connection with FIG. 8.

As illustrated in FIG. 3, the interface 370 includes a list of instance names under the heading “External ID.” The names of the instances include, for example, “DC5823CONVO1106,” “DC5823CONVO1115,” etc. Additional information corresponding to the instances can be listed in columns in interface 370, as illustrated in FIG. 3, for instance. This information can include the display name of each instance, the name of the object that each instance represents (e.g., “SOURCE OBJECT”), the space in which each source object is located, the template used to create each instance, the site in which each source object is located, and the name(s) of object(s) that supply each object.

In some embodiments, selection of an instance from the list illustrated in interface 370 causes the display of detailed information associated with the selected instance. In some embodiments, selection of an instance from the list illustrated in interface 370 allows the modification of the selected instance. Selection of a display element (“create” button 372) can allow the creation of a new instance using a different interface, described below in connection with FIG. 5. Selection of the toggling display element 368 can toggle the display to the plurality of object instances, described above in connection with FIG. 2.

FIG. 4A is a portion of a screenshot of an example interface for customizing an object template, in accordance with one or more embodiments. FIG. 4B is another portion of the screenshot of the example interface illustrated in FIG. 4A. FIGS. 4A and 4B are cumulatively referred to herein as “FIG. 4.”

FIG. 4 is a screenshot of an example interface 474 for customizing an object template in accordance with one or more embodiments. Interface 474 can be provided (e.g., displayed) as a user interface of a computing device, such as, for instance, user interface 898 of computing device 892 further described in connection with FIG. 8.

Creating an object template can include utilizing the interface 474 to specify the particular attributes, relationships, and metrics that will be available to be populated with specific instance information when the template is later used to create an instance (described below in connection with FIG. 5). Accordingly, as illustrated in FIG. 4, the interface 474 can include a plurality of portions: a basic information portion 476, an attributes portion 478, a relationships portion 480, and a metrics portion 482, though embodiments herein are not limited to these example portions. It is noted that the term “portion,” as referred to herein, is a unit of an interface (e.g., a display). In some embodiments, a portion refers to a subset of an interface, such as a window, for instance. In some embodiments, a portion refers to a display element (e.g., a button) of an interface. In some embodiments, a portion refers to a page that constitutes an entirety of a display.

The basic information portion 476 can include the parent template of the template being created, the name of the template being created, the External ID of the template being created, an indication of whether the template being created is a custom template, a version of the template being created, etc. Selection of, and/or input into, any of the display elements of the basic information portion 476 can represent an operation that triggers a change to the object modeling platform's state and is herein described as a command (discussed in more detail below in connection with FIG. 6).

The attributes portion 478 can include attributes of the template being created. The attributes portion 478 can allow the customization of which attributes (e.g., attributes of objects represented by instances created using the template) are to be included in the template. Attributes may include, for example, display name, category, class, type, manufacturer, manufactured year, description, serial number, purchase date, installation date, etc. As the template being created in the example illustrated in FIG. 4 is a “pump” template, the attributes portion 478 is shown as including a “suction port” field and a “discharge port” field. It is to be understood that these specific fields may be present in a pump template and absent in a golf cart template, for instance. Selection of, and/or input into, any of the display elements of the attributes portion 478 can represent an operation that triggers a change to the object modeling platform's state and is herein described as a command (discussed in more detail below in connection with FIG. 6).

The relationships portion 480 can include relationship information corresponding to the template being created. The relationships portion 480 can allow the customization of what relationship information (e.g., relationship information corresponding to objects represented by instances created using the template) is to be included in the template. Relationship information may include, for example, site, spatial location, spatial service, etc. Selection of, and/or input into, any of the display elements of the relationships portion 480 can represent an operation that triggers a change to the object modeling platform's state and is herein described as a command (discussed in more detail below in connection with FIG. 6).

The metrics portion 482 can include metrics of the template being created. The metrics portion 482 can allow the customization of which metrics (e.g., metrics corresponding to objects represented by instances created using the template) are to be associated with (e.g., included in) the template. Metrics may include, for example, status, energy usage, availability, performance, motor revolutions per minute (RPM), pressure in, pressure out, flow rate, etc. Selection of, and/or input into, any of the display elements of the metrics portion 482 can represent an operation that triggers a change to the object modeling platform's state and is herein described as a command (discussed in more detail below in connection with FIG. 6).

A user can indicate the basic details, attributes, relationships, and metrics to be included in a template via the basic details portion 476, the attributes portion 478, the relationships portion 480, and the metrics portion 482, respectively, of the interface 474. As such, a user can customize a variety of aspects of templates using the interface portions described in connection with FIG. 4. Indications made by a user, of the basic details, attributes, relationships, and/or metrics to be included can be operations that trigger a change to the object modeling platform's state and are herein described as commands (discussed in more detail below in connection with FIG. 6).

FIG. 5 is a screenshot of an example interface 584 for customizing an instance in accordance with one or more embodiments. Interface 584 can be provided (e.g., displayed) as a user interface of a computing device, such as, for instance, user interface 898 of computing device 892 further described in connection with FIG. 8.

The example illustrated in FIG. 5 depicts an instance being created from the template previously described in connection with FIG. 4. For example, the instance “CentrPump_001,” having been created using the template previously created using the interface 474 (previously described in connection with FIG. 4) can be customized using the interface 584. Accordingly, the basic details portion 576, the attributes portion 578, and the metrics portion (not shown in FIG. 5) include the basic details, the attributes, and the metrics that were previously customized using the interface 474. In some embodiments, the values of the various basic details, attributes, and/or metrics are user-entered. In some embodiments, the values the values of the various basic details, attributes, and/or metrics are received from a device. For example, the values can be received via an optical scan of a bar code associated with the object or from a computing device. In some embodiments, the values of the various basic details, attributes, and/or metrics are received from the object itself or from a sensing device associated with the object (e.g., in real time). Reception(s) of such values represent operations that trigger a change to the object modeling platform's state and are herein described as commands (discussed in more detail below in connection with FIG. 6).

In some examples, the customization of templates can include the ability to create and modify notifications corresponding to object instances created using object templates. In some embodiments, the interface 474, previously described in connection with FIG. 4, can include a portion configured to receive a request to provide a notification regarding the object. Reception of such a request can represent an operation that triggers a change to the object modelling platform's state and are herein described as commands (discussed in more detail below in connection with FIG. 6). In some embodiments, such a portion may be entitled “NOTIFICATIONS” and may be displayed in a manner analogous to the basic details portion 476, the attributes portion 478, the relationships portion 480, and the metrics portion 482. In some embodiments, a portion of the interface dedicated to notifications may be presented separately (e.g., responsive to the selection of a display element in the interface 474).

FIG. 6 illustrates a flow chart associated with object modeling using event sourcing and CQRS in accordance with one or more embodiments. The steps of the flow chart illustrated in FIG. 6 can be performed by, for example, a computing device such as that described below connection with FIG. 8, for instance.

As shown in FIG. 6, a command can be generated by a client 671. The client 671 can be an object modeling platform, as previously described herein. In some embodiments, the object modeling platform includes an interface having a plurality of portions and can be accessed by a computing device, for instance, to modify an entity. The entity can be, for example, an object instance or an object instance template, as previously described herein. In some embodiments, the command is generated responsive to receiving a request to modify the entity in the object modeling platform. The request to modify the entity can include a request to create the entity, a request to delete the entity, a request to customize an aspect of the entity, or a request to configure an asset. Such a request can comprise a selection of a display element made using the interface and/or other inputs, such as alphanumeric inputs (e.g., typed data entries) made using the interface, as previously described herein.

A command handler 673 can perform a validation on the command (e.g., validate the command). Following a successful validation, the command can be communicated (e.g., sent) to a first event bus 675, as illustrated in FIG. 6. If the validation is unsuccessful (e.g., yields one or more errors), the command can be sent back to the client 671.

As shown in FIG. 6, an aggregation function 679 can be executed to receive the command from the first event bus 775 and process the command. In some embodiments, to process the command, the aggregation function 679 can consult a reference model 683, for instance. Reference models 683, 689, and 695, illustrated in FIG. 6, can be standardized and/or common models that can be used as both read and write data models by providing a consistent way to represent entities such as object types, units, currency, etc. An identifier (e.g., command identifier) of the processed command can be stored in a write model persistence layer 681. An aggregate root of the processed command can be stored in the write model persistence layer 681, and a domain of the command can be validated. In some embodiments, only a portion of the data associated with the domain validation (e.g., the data to be used in the domain validation) may be stored by the write model persistence layer 681. If the domain validation fails, an indication of an error event can be communicated to a second event bus 685.

Responsive to a successful validation of the domain of the command by the aggregation function 679, the aggregation function 679 can generate one or more events associated with the command and communicate the event(s) to the second event bus 685, as illustrated in FIG. 6. The event(s) can be associated with a topic. A topic can allow additional listeners to act on the event(s), and can allow the detection of duplicate events (e.g., the event can be determined to be a duplicate event based on the topic).

A projection function 687 can be executed to update a read model 691 with the event received from the second event bus 685. While a single projection function 687 is illustrated in FIG. 6, embodiments herein can include a plurality of projection functions 687, each of which can be responsible for updating a respective read model 691. While a single read model 691 is illustrated in FIG. 6, embodiments herein can include a plurality of read models 691, each associated with a respective portion of an interface, such as those described above. Accordingly, it is to be understood that not all events necessarily cause all of the read models 691 to be updated.

The events received from the second event bus 685 can correspond to either a successfully validated command or to a validation error. The success or failure of the command validation can indicate that the command has been completed. After generating the command as described above, the client 671 can poll one or more query handlers 693 for an indication of command completion. Such polling can be performed for a configurable period of time (e.g., a configurable timeout). Once the command has been completed, the client 671 can receive an indication of the completion of the command from query handler 693, including an event associated with either an error or a successful validation. An error can be displayed via the client's interface. A successful command validation can result in the entity being modified in the object modeling platform according to the request. If the command validation fails, the modification of the entity can be withheld.

In some instances, the client 671 may request data associated with an entity, either in addition to, or rather than, the request to modify the entity. In such instances, the query handler 693 can receive the request for data and query the read model 691 for the requested data and send (e.g., return) the requested data to the client 671.

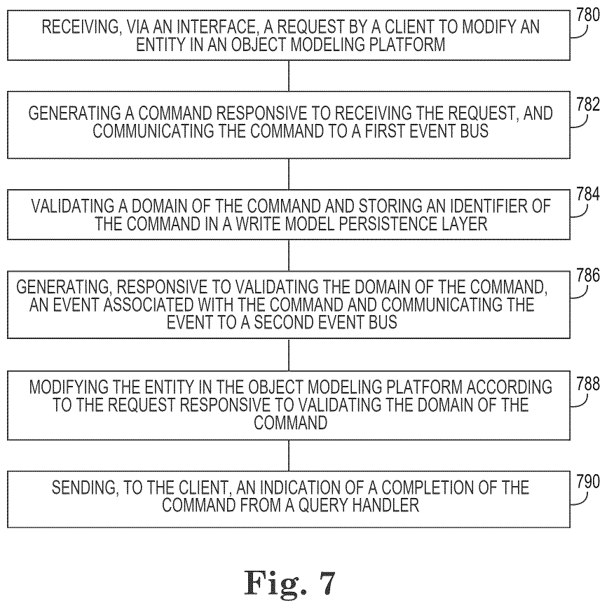

FIG. 7 illustrates an example of a method for extensible object modeling using event sourcing and CQRS, in accordance with one or more embodiments. The method can be performed by, for example, a computing device such as that described below connection with FIG. 8, for instance.

At 780, the method includes receiving, via an interface (e.g., the interfaces previously described in connection with FIGS. 2, 3, 4, and/or 5), a request by a client to modify an entity in an object modeling platform. In some embodiments, the entity is an object instance. In some embodiments, the entity is an object instance template. Receiving the request to modify the entity can include receiving a request to create the entity, receiving a request to delete the entity, and/or receiving a request to customize an aspect of the entity, as previously described herein.

At 782, the method includes generating a command responsive to receiving the request, and communicating the command to a first event bus (e.g., event bus 675 previously described in connection with FIG. 6). In some embodiments, the method includes performing a validation on the command (e.g., by a command handler) before communicating the command to the first event bus, as previously described herein.

At 784, the method includes validating a domain of the command and storing an identifier of the command in a write model persistence layer (e.g., write model persistence layer 681 previously described in connection with FIG. 6). In some embodiments, only a portion of the data associated with the domain validation (e.g., the data to be used in the domain validation) may be stored along with the identifier.

At 786, the method includes generating, responsive to validating the domain of the command, an event associated with the command and communicating the event to a second event bus (e.g., event bus 685 previously described in connection with FIG. 6). The event can be associated with a topic. A topic can allow additional listeners to act on the event. A topic can allow the detection of duplicate events.

At 788, the method includes modifying the entity in the object modeling platform according to the request responsive to validating the domain of the command. Some embodiments include communicating an indication of an error to the second event bus responsive to a failure to validate the domain of the command. Some embodiments include withholding modification of the entity in the object modeling platform according to the request responsive to a failure to validate the domain of the command. At 790, the method includes sending, to the client, an indication of a completion of the command from a query handler (e.g., query handler 693 previously described in connection with FIG. 6).

FIG. 8 is an example of a computing device 892 for extensible object modeling using event sourcing and CQRS, in accordance with one or more embodiments. As illustrated in FIG. 8, the computing device 892 can include a memory 894, a processor 896, and a user interface 898 for extensible object modeling using event sourcing and CQRS, in accordance with the present disclosure.

The memory 894 can be any type of storage medium that can be accessed by the processor 896 to perform various examples of the present disclosure. For example, the memory 894 can be a non-transitory computer readable medium having computer readable instructions (e.g., executable instructions/computer program instructions) stored thereon that are executable by the processor 896 for extensible object modeling using event sourcing and CQRS in accordance with the present disclosure.

The memory 894 can be volatile or nonvolatile memory. The memory 894 can also be removable (e.g., portable) memory, or non-removable (e.g., internal) memory. For example, the memory 894 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 894 is illustrated as being located within computing device 892, embodiments of the present disclosure are not so limited. For example, memory 894 can also be located internal to another computing resource (e.g., enabling computer readable instructions to be downloaded over the Internet or another wired or wireless connection).

The processor 896 may be a central processing unit (CPU), a semiconductor-based microprocessor, and/or other hardware devices suitable for retrieval and execution of machine-readable instructions stored in the memory 894.

As shown in FIG. 8, computing device 892 can include a user interface 898. A user of computing device 892 can interact with computing device 892 via user interface 898. For example, the user interface 898 can provide (e.g., display and/or present) information to the user of computing device 892, and/or receive information from (e.g., input by) the user of computing device 892. For instance, in some embodiments, user interface 898 can include a graphical user interface (GUI) that can provide and/or receive information to and/or from the user of computing device 892. The GUI can be, for instance, a touch-screen (e.g., the GUI can include touch-screen capabilities). As an additional example, user interface 898 (e.g., the GUI) can include a keyboard and/or mouse. However, embodiments of the present disclosure are not limited to a particular type of user interface.

As an example, user interface 898 can provide (e.g., display) the screenshots previously described in connection with FIGS. 2, 3, 4, and 5, to a user of computing device 892. For instance, user interface 898 can provide (e.g., display) an interface for customizing an object template in an object modeling platform, as previously described herein. Further, user interface 898 can receive selections of causes, manners, etc., as previously described herein.

The user interface 898 can be localized to any language. For example, the user interface 898 can display information in any language, such as English, Spanish, German, French, Mandarin, Arabic, Japanese, Hindi, etc.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, via an interface, a request by a client to modify an entity in an object modeling platform;
generating a command responsive to receiving the request, and communicating the command to a first event bus;
validating a domain of the command and storing an identifier of the command in a write model persistence layer;
generating, responsive to validating the domain of the command, an event associated with the command and communicating the event to a second event bus;
modifying the entity in the object modeling platform according to the request responsive to validating the domain of the command; and
sending, to the client, an indication of a completion of the command from a query handler.

2. The method of claim 1, wherein the entity is an object instance template.

3. The method of claim 1, wherein the entity is an object instance.

4. The method of claim 1, wherein receiving the request to modify the entity includes receiving a request to create the entity.

5. The method of claim 1, wherein receiving the request to modify the entity includes receiving a request to delete the entity.

6. The method of claim 1, wherein receiving the request to modify the entity includes receiving a request to customize an aspect of the entity.

7. The method of claim 1, wherein the method includes communicating an indication of an error to the second event bus responsive to a failure to validate the domain of the command.

8. The method of claim 1, wherein the method includes withholding modification of the entity in the object modeling platform according to the request responsive to a failure to validate the domain of the command.

9. The method of claim 1, wherein the method includes updating a read model persistence layer with the event.

10. The method of claim 1, wherein the method includes associating a topic with the event in the second event bus.

11. The method of claim 10, wherein the method includes determining that the event is a duplicate event based on the topic associated with the event.

12. A non-transitory machine-readable medium having instructions stored thereon which, when executed by a processor, cause the processor to:
receive, via an interface, a request by a client to modify an entity in an object modeling platform, wherein the request to modify the entity includes a request to customize an aspect of the entity;
generate a command responsive to receiving the request, and communicate the command to a first event bus;
validate a domain of the command and store an identifier of the command in a write model persistence layer;
generate, responsive to validating the domain of the command, an event associated with the command and communicate the event to a second event bus;
modify the entity in the object modeling platform according to the request responsive to validating the domain of the command; and
send, to the client, an indication of a completion of the command from a query handler.

13. The medium of claim 12, wherein the request to customize the aspect of the entity is received responsive to a selection of a display element made using the interface.

14. The medium of claim 12, wherein the request to customize the aspect of the entity is received responsive to an alphanumeric input made using the interface.

15. The medium of claim 12, wherein the request to customize the aspect of the entity includes a request to customize a relationship between the entity and an object of the object modeling platform.

16. A computing device, comprising:
a user interface;
a processing resource; and
a memory resource storing non-transitory machine-readable instructions to cause the processing resource to:
receive, via the user interface, a request by a client to modify an entity in an object modeling platform;
generate a command responsive to receiving the request, and communicate the command to a first event bus;
validate a domain of the command and store an identifier of the command in a write model persistence layer;
generate, responsive to validating the domain of the command, an event associated with the command and communicate the event to a second event bus;
associate a topic with the event in the second event bus;
modify the entity in the object modeling platform according to the request responsive to validating the domain of the command; and
send, to the client, an indication of a completion of the command from a query handler.

17. The computing device of claim 16, wherein the instructions include instructions to:
receive, via the user interface, a request by the client for data associated with the entity in the object modeling platform;
send, to the client, the requested data from the query handler.

18. The computing device of claim 16, wherein the request to modify the entity is a request to associate a metric with the entity.

19. The computing device of claim 16, wherein the instructions include instructions to determine that the event is a duplicate event based on the topic associated with the event.

20. The computing device of claim 16, wherein the request to modify the entity is a request to configure an asset.
